(19) United States
(12) Patent Application Publication
(10) Pub. No.: US 2022/0141343 A1
(43) Pub. Date: May 5, 2022

(54) Multipurpose Drawing Tablet

(71) Applicant: Nancy Ford, Alpharetta, GA (US)

(72) Inventor: Nancy Ford, Alpharetta, GA (US)

(21) Appl. No.: 17/505,869

(22) Filed: Oct. 20, 2021

Related U.S. Application Data
(60) Provisional application No. 63/108,919, filed on Nov. 3, 2020.

(51) Int. Cl. H04N 1/00; G06F 3/041; G06F 3/0354

(52) U.S. Cl. CPC H04N 1/00278; G06F 3/0412; H04N 1/00411; H04N 2201/0094; H04N 1/0032; G06F 3/03545; G06F 3/03547

(57) ABSTRACT

The present invention relates to a device, method, and system for drawing, printing, and uploading an artwork or picture drawn on a touch surface. A multipurpose drawing tablet is designed for enabling children to draw on a touch surface with a stylus or a finger. The tablet features a touch surface for sensing pressure and movement of the stylus or finger, a built-in printer for printing a drawn picture or artwork on the touch surface, a paper feeding slot for feeding physical papers for printing, and a wireless communication module for establishing a wireless channel with at least one handheld electronic device for transmitting the drawn picture or artwork. A computer implemented application receives the artwork or picture and stores and uploads to a cloud storage, a website, or any social media.

### CROSS-REFERENCE TO RELATED APPLICATION

The present application claims priority to, and the benefit of, U.S. Provisional Application No. 63/108,919, which was filed on Nov. 3, 2020 and is incorporated herein by reference in its entirety.

### FIELD OF THE INVENTION

The present invention relates generally to the field of electronic devices. More specifically, the present invention relates to a multipurpose digital drawing tablet device capable of enabling children to draw on the surface and print out their creations using an integrated printer system. The digital drawing pad features a flat surface to enable a user to draw, a storage slot for storing paper/sheets and a thin slot for dispensing the paper printed with the drawing drawn by the user. Also, the digital drawing tablet device enables the user to pair the tablet with a compatible software application to upload the drawing/art to a website or social media application to share the work with friends and family. The invention offers a convenient way of identifying the art and enables it to be easily shared on different platforms. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, children are encouraged to draw and illustrate in order to enhance their creative skills, develop fine motor skills, encourage visual analysis, improve hand-eye coordination and more. Children of any age, especially young children, can be creative and may enjoy drawing. Generally, at home and in schools, children are encouraged to draw on paper. However, the drawings can be easily lost throughout the years, if the pictures/drawings drawn by the children are not kept and organized properly. Also, in case children forget to write their name, date, title, description and other details on their drawing sheet, and if parents or teachers pack them away, then there is no way to determine the identity of the drawing sheet later on. With no information on the drawing sheets, individuals can have a difficult time in identification of the drawing sheets.

A lot of devices have been developed to provide enhanced resources to encourage drawing among children. For example, various kinds of tablet devices are available in the state of the art, that enable the users to draw on their surfaces. However, these drawings are difficult to print out and can be erased easily. To print the drawings on tablet devices, individuals have to separately buy a printer and then send the drawings on the tablet devices to the printer to make the required printout. However, buying a separate printer can be an expensive option. Additionally, sending the drawing files to the printer requires both a tablet and a printer to be connected to a communication network such as Wi-Fi, and in case one of the devices is not connected to the communication network, a person will be unable to make the printout. The complete process of making a printout of a drawing on tablet devices is time-consuming and wastes a lot of the users' time.

Therefore, there exists a long felt need in the art for a device that enables the users to easily draw pictures on its surface. There is also a long felt need in the art for a device that eliminates the need to buy and set up a printer separately in order to make printouts of drawings on a tablet device. Additionally, there is a long felt need in the art for a drawing pad that enables the users to save the drawings drawn on its surface, along with details such as name, date, title and more. Moreover, there is a long felt need in the art for a tablet device that does not require children to write details such as name, date, title, description and other information on their drawing sheets, and prints such information on the drawing sheet as per the desires of the users. Further, there is a long felt need in the art for a drawing pad device that enables the parents/teachers to easily determine the identity of any drawing sheet. Furthermore, there is a long felt need in the art for a tablet device that does not require the tablet and a printer to be connected to a communication network to make a printout of any drawing drawn on the surface of the tablet device. Also, there is a long felt need in the art for a tablet device that provides a hassle-free printout-making solution that saves the time of the users. Finally, there is a long felt need in the art for a tablet device that enables the users to draw and make a printout of the drawn picture using a single device.

The subject matter disclosed and claimed herein, in one embodiment thereof, comprises a multipurpose drawing tablet. The multipurpose drawing tablet enables children to draw on a touch surface with a stylus or a finger. More specifically, the tablet includes a touch surface having touch sensors for sensing pressure and movement of the stylus or finger, a built-in printer for printing the drawn picture or artwork on the touch surface, a paper feeding slot for feeding physical papers for printing and a wireless communication module for establishing a wireless channel with at least one handheld electronic device for transmitting the drawn picture or artwork. The electronic device includes an installed computer-implemented application for uploading said picture or artwork to a cloud storage, a website and one or more social media applications.

In this manner, the novel multipurpose drawing tablet device of the present invention accomplishes all of the forgoing objectives, and provides a relatively easy, convenient and quick solution to draw pictures and make their printouts without having a separate printer setup. The multipurpose digital drawing tablet device of the present invention is also user-friendly, as it eliminates the need to buy a separate printer and saves the time and money of the users. The multipurpose digital drawing tablet device enables the users to print the drawing with identification information that helps the users in organizing the drawings properly. Additionally, using a software application of the multipurpose digital drawing tablet device, the users can easily share their drawings with others over a wireless communication network.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose drawing tablet. The multipurpose drawing tablet is designed for enabling children to draw on a touch surface with a stylus or a finger. The tablet further comprises a touch surface for sensing pressure and movement of the stylus or finger, a built-in printer for printing drawn pictures or artwork on the touch surface, a paper feeding slot for feeding physical papers for printing, and a wireless communication module for establishing a wireless channel with at least one handheld electronic device for transmitting the drawn picture or artwork. Further, the touch surface provides color options for selection to fill a selected portion of the picture or artwork and an electronic eraser for erasing a portion of the picture or artwork or completely blanking the touch surface.

In yet another embodiment of the present invention, a clear-all option is provided for clearing the touch surface by erasing all the drawn pictures or artwork. A plurality of pre-defined shapes is also provided for selection. In yet another embodiment, a push button is used for activating the tablet and a micro-USB charging port is used for charging an internal battery of the tablet. Further, any touch-sensitive technologies including resistive, capacitive, surface capacitance, optical (e.g., infrared), strain gauge, dispersive signal, acoustic pulse recognition or other similar technologies. Preferably, the touch-sensitive technology used is inkless and paperless.

In yet a further embodiment of the present invention, a system for uploading an artwork created by a child on a drawing tablet is disclosed. The system includes a touch surface-based drawing tablet and a computer implemented software application configured to be installed in an electronic device wherein the electronic device is connected to the drawing tablet using a wireless connection. The software application provides one or more user interfaces for receiving an artwork or picture from the drawing tablet and uploading the received artwork or picture to one or more of a cloud storage, a website and a social media application. Further, the software application enables a user to add voiceover to the artwork or picture before the uploading, wherein the voiceover is performed using the microphone of the electronic device.

In yet another embodiment of the present invention, a method for printing inkless and paperless artwork drawn on a touch surface of a portable drawing pad is described. The method includes initially drawing an artwork or picture on the touch surface using a stylus, then selecting a print touch button displayed on the touch surface, and printing the artwork or picture using a built-in printer of the drawing tablet or pad. The method further includes feeding paper into a paper slot for printing the artwork or picture, and selecting one or more colors and shapes for creating the artwork or picture.

In yet another embodiment of the present invention, a printed paper contains printed artwork or pictures on the front surface and the name of the owner, title, and date of printing/creating the artwork or picture on the back surface. The printed paper is a colored printed paper printed using the integrated color printer.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of the multipurpose electronic tablet of the present invention in accordance with the disclosed architecture;

FIG. 2 illustrates a perspective view showing a user drawing on the multipurpose electronic tablet of the present invention in accordance with the disclosed architecture;

FIG. 3 illustrates a perspective view showing a printout of a drawing/picture using built-in printer system of multipurpose drawing tablet of the present invention in accordance with the disclosed architecture;

FIG. 4 illustrates a perspective view of back surface of the printed paper containing drawing or picture dispensed from the multipurpose drawing tablet of the present invention in accordance with the disclosed architecture;

FIG. 5 illustrates a flow diagram showing steps for generating a drawing or an artwork on digital drawing pad of the present invention in accordance with the disclosed architecture;

FIG. 6 illustrates a schematic view showing connection of the multipurpose drawing tablet of the present invention with an electronic device for uploading a drawing or artwork to a website or social media application in accordance with the disclosed architecture; and

FIG. 7 illustrates a block diagram of showing exemplary user interface containing various operations offered by the companion software application in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a device that enables the users to easily draw pictures on its surface. There is also a long felt need in the art for a device that eliminates the need to buy and set up a separate printer in order to make a printout of the drawings on a tablet device. Additionally, there is a long felt need in the art for a drawing pad that enables the users to save the drawings drawn on its surface, along with details such as name, date, title and more. Moreover, there is a long felt need in the art for a tablet device that does not require the children to write details such as name, date, title, description and other information on their drawing sheets, and prints such information on the drawing sheet as per the desires of the users. Further, there is a long felt need in the art for a drawing pad device that enables the parents/teachers to easily determine the identity of any drawing sheet. Furthermore, there is a long felt need in the art for a tablet device that does not require the tablet and printer to be connected to a communication network to make a printout of any drawing drawn on the surface of the tablet device. Also, there is a long felt need in the art for a tablet device that provides a hassle-free printout-making solution that saves the time of the users. Finally, there is a long felt need in the art for a tablet device that enables the users to draw and make a printout of the drawn picture using a single device.

The present invention, in one exemplary embodiment, is a novel method for printing inkless and paperless artwork drawn on a touch surface of a portable drawing pad. The method includes initially drawing an artwork or picture on the touch surface using a stylus, then selecting a print touch button displayed on the touch surface, and printing the artwork or picture using a built-in printer of the drawing pad. The method further includes feeding paper into a paper slot for printing the artwork or picture, selecting one or more colors and shapes for creating the artwork or picture.

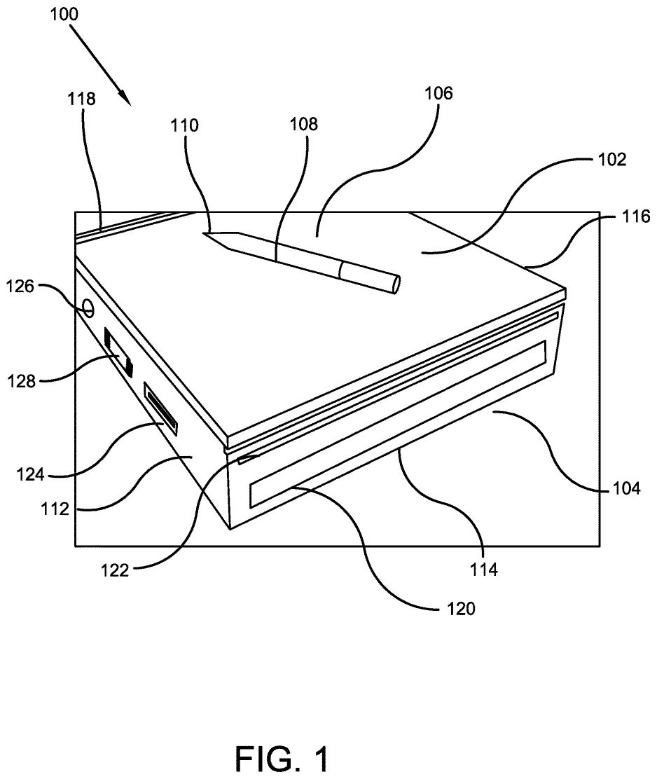

Referring initially to the drawings, FIG. 1 illustrates a front perspective view of one potential embodiment of the multipurpose electronic tablet of the present invention in accordance with the disclosed architecture. The multipurpose electronic tablet 100 of the present invention is a digital drawing pad that enables children to draw and create artwork and pictures. The drawing tablet 100 is geared towards children but can be used by adults as well. The drawings created on the drawing tablet 100 can be printed and a physical copy of the drawing or picture can be accessed from the tablet 100. The drawing tablet 100 is small, compact and lightweight, and comes with a protective case for protecting the tablet 100 from physical damages.

The multipurpose tablet 100 includes a generally rectangular or square shape and includes an appearance similar to a conventional electronic tablet. The tablet 100 includes a top surface 102, a bottom surface 104, a front surface 114, a rear surface 118, a left surface 112 and a right surface 116. The mentioned surfaces provide a single portable tablet unit 100 that houses the internal components of the tablet 100. The internal components will be described further in the disclosure. The top surface 102 includes, in one potential embodiment, a 5″×7″ touchscreen display surface 106. The touchscreen 106 includes integrated touchscreen sensors to detect the touch of a user and operate the tablet 100 accordingly. The touchscreen display 106 features a built-in touchscreen monitor with a pressure-sensitive surface, thereby enabling a child to draw using a stylus or electronic pen 108. The stylus pen 108 is a pen-shaped instrument designed specifically for touch screen use. The stylus pen 108 includes a tip 110 that can be made from a conductive rubber or a capacitive hard plastic and the pressure of the tip 110 is monitored by the built-in touchscreen monitor to draw the movements or figures a child is drawing on the touchscreen 106. The top surface 102 can provide a protective layer to protect the touchscreen 106 from any physical damage.

Exemplary embodiments of the present invention may be described herein with respect to contact or movement of the stylus 108 relative to the touchscreen display surface 106. It should be understood, however, that any contact or movement may alternatively be performed by any electronic pen or finger. Also, the touchscreen 106 can use any touch-sensitive technologies including resistive, capacitive, surface capacitance, optical (e.g., infrared), strain gauge, dispersive signal, acoustic pulse recognition or other similar technologies. Preferably, the touch-sensitive technology used is inkless and paperless.

The left surface 112 includes a power ON/OFF button 126 that is used to turn ON and turn OFF the tablet 100. Further, the left surface 112 includes a micro-USB charging port 124 that enables charging of the tablet 100 using a USB charging cable. The micro-USB charging port 124 is used for recharging the in-built rechargeable battery (not shown in FIG. 1). The front surface 114 is integrated with a printer paper feed slot 120 for feeding paper for printing a picture or drawing drawn on the touchscreen 106. The front surface 114 also includes a thin slot 122 for dispensing printed papers with the drawings or pictures printed on them.

The tablet 100 of the present invention can be used for encouraging children with artistic talents, young doodlers and novice illustrators. The top surface 102 is scratch-proof and waterproof which provides protection to the touchscreen 106 against physical damages. The touchscreen 106 receives a user input comprising a pressure and a direction from the stylus 108 to draw pictures and doodles. The top surface 102 provides an area for a child to interact with the touchscreen 106. Generally, the top surface 102 is a planar area on the top of the tablet 100. However, in other embodiments, the top surface 102 may include a rounded region, an edge region and/or a corner region of the outer surface of the tablet 100.

The drawing pad/tablet 100 includes an integrated wireless communication module 126 that establishes a wireless connection based on Bluetooth, Wi-Fi, or any other similar wireless technology with a handheld electronic device. The wireless connection is used for wirelessly transmitting the artwork from the tablet 100 to the connected electronic device.

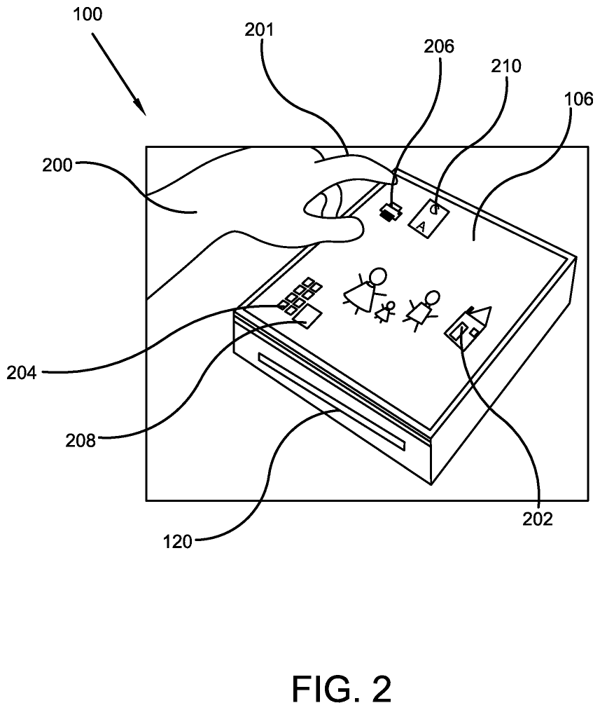

FIG. 2 illustrates a perspective view showing a user drawing on the multipurpose electronic tablet of the present invention in accordance with the disclosed architecture. As shown in FIG. 2, the multipurpose tablet 100 includes a touchscreen display 106 that acts as a digital drawing pad for enabling a user 200 such as a child to draw pictures and write content by touching the screen with one or more fingers 201, or using a stylus as described in FIG.1. A child draws a picture 202 by making figures and shapes on the touchscreen display 106. A plurality of color options 204 in the form of a color palette are displayed on the touchscreen 106 that enables selection of one or more colors for drawing the picture 202. The color options 204 can be selected to enable a user to apply a selected color to a selected area of the picture 202. To fill a color in a selected area, a color is selected by clicking on a color from the color option and then an area to which the selected color is to be applied is selected. To erase a portion of the picture 202, the touchscreen displays an electronic eraser 208, which is selected and then a portion of the picture 202 is selected to erase. To clear the touchscreen surface 106, a Clear All option shown as “CA” 210 is provided to the user. When the “CA” option 210 is selected, the touchscreen display 106 becomes blank for a user to create a new picture.

The tablet 100 is integrated with a built-in printer feature for printing the drawing 202 displayed on the touchscreen 106. A print touch button 206 is shown on the touchscreen 106 is selected for printing the drawing 201. The drawing 202 dispensed from the printer slot 122 of the tablet 100. For printing the drawings created in the tablet 100, a paper feeding slot 120 can be used. A maximum of twenty papers can be fed into the paper feeding slot 120. However, the storage capacity of the paper feeding slot 120 is not limited, and can be designed to fulfil the needs and requirements of the user, while keeping the tablet 100 compact and lightweight. In one potential embodiment, when the user selects the print touch button 206, the user may provide a title of the drawing and the signature or name of the artist or the user. The provided information along with the timestamp (date) is printed on the back surface of a printed paper containing the printed drawing 202.

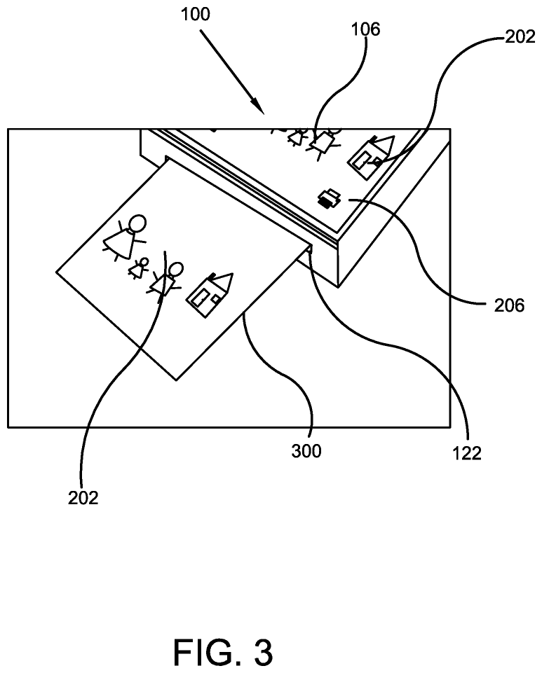

FIG. 3 illustrates a perspective view showing a printout of a drawing/picture using the built-in printer system of the multipurpose drawing tablet of the present invention in accordance with the disclosed architecture. As stated earlier, the multipurpose drawing tablet 100 is integrated with a built-in printer system that is activated using the print touch button 206 displayed on the touch surface 106. When the print touch button 206 is activated using a stylus or finger, a physical copy of the artwork, picture or drawing 202 is generated on a paper fed inside the printer paper feed slot, and the printed version 300 is dispensed through the printer slot 122. The papers for printing are pre-fed into the device 100 inside the printer paper feed slot/storage space. In various embodiments of the invention, printing papers can be of various sizes to be stored in an internal paper slot of the device 100.

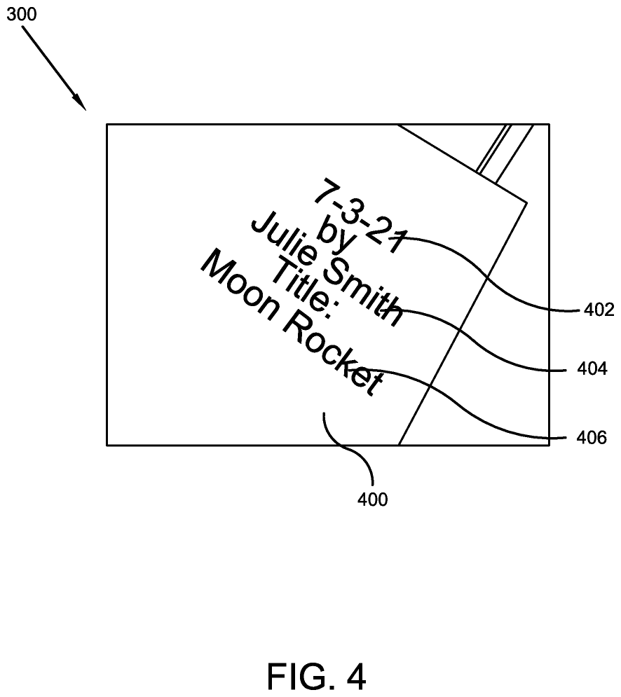

FIG. 4 illustrates a perspective view of the back surface of the printed paper containing the drawing or picture dispensed from the multipurpose drawing tablet of the present invention in accordance with the disclosed architecture. As shown in FIG. 4, the back surface 400 of the printed paper 300 includes a date 402, a name 404 and a title 406. This printed information on the back surface 400 of the printed paper 300 can help to identify the artwork printed on the paper 300. The date 402 can be provided using a built-in clock of the tablet device 100 and the name 404 can be that user's profile using the tablet device 100. Alternatively, when a child presses the print button (as stated earlier) displayed on the touchscreen of the tablet device 100, the user can provide the title of the drawing 406 along with the name of the artist 404.

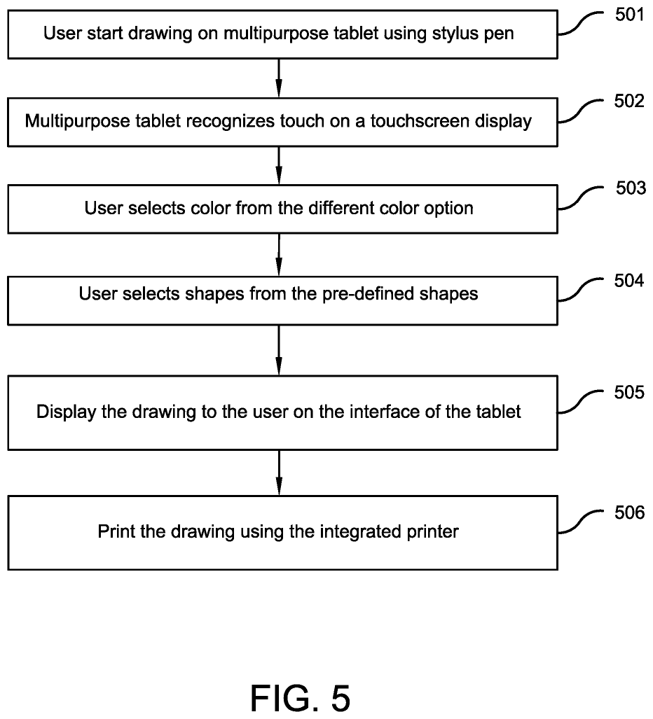

FIG. 5 illustrates a flow diagram showing steps for generating a drawing or an artwork on the digital drawing pad of the present invention in accordance with the disclosed architecture. Initially, a user such as a child starts drawing on the digital drawing pad or multipurpose tablet device using a stylus pen, one or more fingers or any other touch-based input device (Block 501). Then, the multipurpose touchscreen display of the device recognizes the user touch on the display surface when the device such as the stylus pen is placed on the touchscreen display surface of the tablet device (Block 502). The shapes and text written by the user are drawn in real-time on the touchscreen. The user as per the preferences, selects different colors from the color options displayed on the touchscreen (Block 503). The user then can select different shapes from a set of pre-defined shapes provided on the touchscreen display surface (Block 504). The pre-defined shapes can include shapes such as trees, geometrical shapes, lines, rectangles and other such types of shapes. Once the user finishes the drawing, the drawing or the artwork is displayed to the user on the touchscreen display surface of the tablet (Block 505). For printing the drawing or the artwork, the drawing can be printed on a physical paper fed into the drawing pad, using a print touch button present in the interface of the digital drawing pad (Block 506).

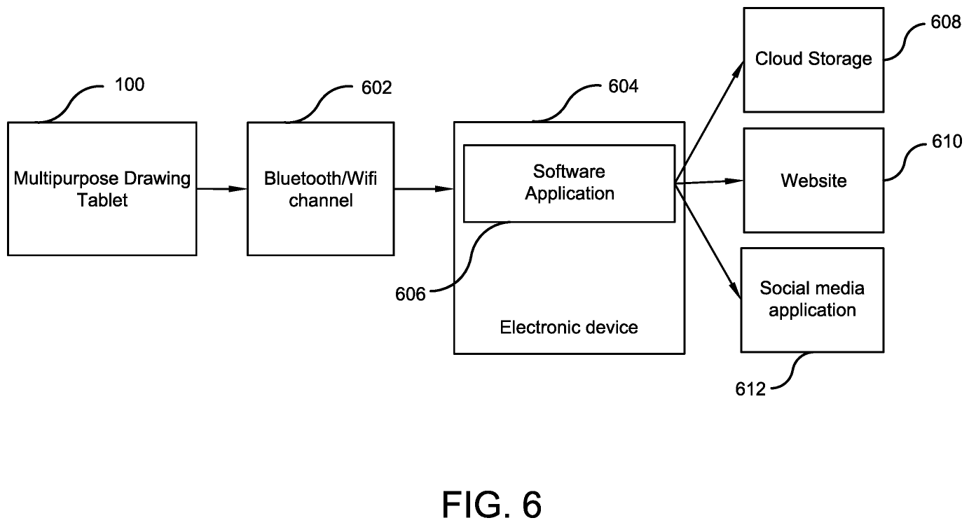

FIG. 6 illustrates a schematic view showing connection of the multipurpose drawing tablet of the present invention with an electronic device for uploading a drawing or artwork to a website or social media application in accordance with the disclosed architecture. The drawing pad 100 of the present invention can wirelessly connect to a handheld electronic device 604 through a wireless channel 600 such as Bluetooth, Wi-Fi or any other similar wireless technology. The smartphone device 604 includes an installed companion software application 606 that is connected to the drawing pad 100 and is configured to receive the drawings from the multipurpose tablet 100. Once a drawing is complete, a user can share the completed drawing using a send button to the one or more paired handheld electronic devices 604, each having a companion software application 606.

The electronic device 604 having software application 606 installed enables a parent to upload the art created by the child to a cloud storage 608, or to a website 610. The website 610 can also be linked with other social media platforms to automatically share the child's artwork with the parents' accounts. In one potential embodiment, the parent can link multiple social network accounts to the profile created on the website 610 enabling automatic syncing of the uploaded artwork to other social media accounts. The software application 606 also enables parents to share the artwork on a specific social media application 612 to share their child's work with friends and family members. A children-specific social media application 612 can be subscribed as an add-on functionality that can have competitions and various levels for the children to achieve. Additionally, various templates can be downloaded from the specific social media application 612, enabling a child to draw on the drawing tab 100 of the present invention.

The smartphone application 606 also enables a user such as a parent to add commentary, notes and voiceover to the artwork before uploading and storing. The application 606 uses the microphone of the electronic device 604 for adding voiceover and audio commentary to the artwork.

The software application is a computer-implemented application stored in a computer-readable storage medium of the electronic device 604. The memory can include volatile computer storage media. For example, the memory can include a random access memory (RAM), including dynamic RAM (DRAM), synchronous dynamic RAM (SDRAM), and/or static RAM (SRAM). In some embodiments, the memory includes non-volatile computer storage media. For example, the memory may include a hard disk drive, a flash memory or any other suitable non-volatile computer storage device. In some embodiments, the memory includes both volatile and non-volatile computer storage media.

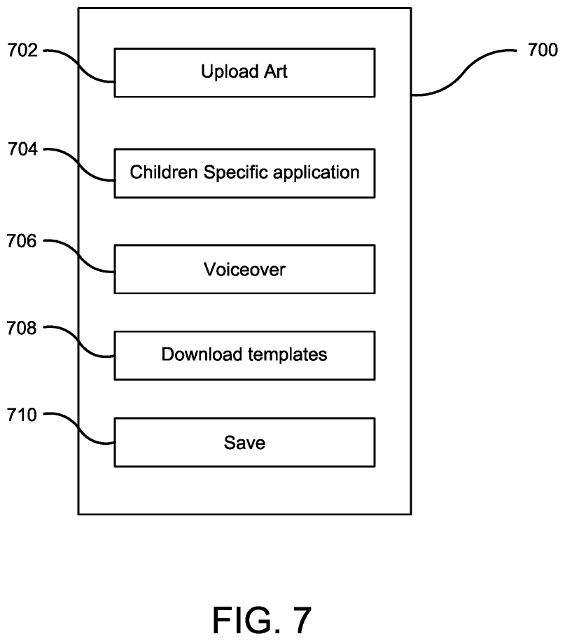

FIG. 7 illustrates a block diagram of an exemplary user interface containing various operations offered by the companion software application in accordance with the disclosed architecture. As stated earlier, the companion software application installed in an electronic device provides users a user interface 700. The user interface 700 includes an upload art option 702 that enables a user such as a parent to upload their child's artwork to a website or social media applications such as Facebook, Instagram or any other such type of application. The upload art option 702 also enables the user to upload the artwork website which can be linked with other social media to automatically share the child's creations with the parent's accounts. The software application enables the parent to upload and share the art to a children-specific social media application using the children-specific application option 704. The user interface 700 also provides parents with a voiceover option 706. The voiceover option 706 enables the parent to add voiceover commands to each drawing so that the parent can describe their child's artwork using voice commands. Other users such as family members and friends can understand the drawing easily by referring to the voiceover. The user can add voiceover commands to the uploaded artwork for further identification and entertainment. The user interface 700 of the software application enables a user to download templates for drawing using the download templates option 708. The user interface 700 provides user with a save option 710, by which a user can save the artwork in the electronic device to preserve their memories.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multipurpose electronic tablet”, “multipurpose digital drawing tablet device”, “multipurpose drawing tablet”, “digital drawing pad”, “drawing tablet”, “portable tablet unit”, “multipurpose tablet” and “tablet”, are interchangeable and refer to the collapsible multipurpose electronic tablet 100 of the present invention.

Notwithstanding the forgoing, the multipurpose electronic tablet 100 of the present invention can be of any suitable size and configuration as is known in the art without affecting the overall concept of the invention, provided that it accomplishes the above-stated objectives. One of ordinary skill in the art will appreciate that the size, configuration, and material of the multipurpose electronic tablet 100 as shown in the FIGS. are for illustrative purposes only, and that many other sizes and shapes of the multipurpose electronic tablet 100 are well within the scope of the present disclosure. Although the dimensions of the multipurpose electronic tablet 100 are important design parameters for user convenience, the multipurpose electronic tablet 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What includes been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multipurpose electronic drawing tablet comprising:
a digital drawing tablet;
an integrated printer;
a touchscreen for creating a drawing thereon; and
a paper storage compartment, wherein said touchscreen comprises a print command for printing said drawing, and further wherein said digital drawing tablet autonomously adding a date to said print command for printing on said drawing.

2. The multipurpose electronic drawing tablet of claim 1 further comprising a memory for saving said drawing.

3. The multipurpose electronic drawing tablet of claim 2, further comprising a micro-USB charging port for charging a built-in battery.

4. The multipurpose electronic drawing tablet of claim 1, wherein said touchscreen is waterproof and scratchproof.

5. The multipurpose electronic drawing tablet of claim 1, wherein said electronic drawing tablet is paired with a software application to upload said drawing to a remote electronic device.

6. The multipurpose electronic drawing tablet of claim 5, wherein said electronic drawing tablet further comprises a microphone for recording a voiceover message with said drawing.

7. The multipurpose electronic drawing tablet of claim 5, wherein said remote electronic device is a smartphone.

8. The multipurpose electronic drawing tablet of claim 5, wherein said remote electronic device is a website.

9. The multipurpose electronic drawing tablet of claim 1 further comprising an electronic eraser for erasing a portion of said drawing.

10. The multipurpose electronic drawing tablet of claim 9 further comprising a clear all option for erasing said drawing.

11. A multipurpose electronic drawing tablet comprising:
a digital drawing tablet;
an integrated printer;
a touchscreen for creating a drawing thereon;
an electronic eraser for erasing a portion of said drawing;
a clear all option for erasing said drawing;
a memory for saving said drawing; and
a paper storage compartment, wherein said touchscreen comprises a print command for printing said drawing.

12. The multipurpose electronic drawing tablet of claim 11 further comprising a micro-USB charging port for charging a built-in battery.

13. The multipurpose electronic drawing tablet of claim 11, wherein said touchscreen is waterproof and scratchproof.

14. The multipurpose electronic drawing tablet of claim 11, wherein said electronic drawing tablet is paired with a software application to upload said drawing to a remote electronic device.

15. The multipurpose electronic drawing tablet of claim 14, wherein said electronic drawing tablet further comprises a microphone for recording a voiceover message with said drawing.

16. The multipurpose electronic drawing tablet of claim 14, wherein said remote electronic device is a smartphone.

17. The multipurpose electronic drawing tablet of claim 14, wherein said remote electronic device is a website.

18. The multipurpose electronic drawing tablet of claim 11, wherein said digital drawing tablet autonomously adding a date to said print command for printing on said drawing.

19. A multipurpose electronic drawing tablet comprising:
a digital drawing tablet;
an integrated printer;
a touchscreen for creating a drawing thereon, wherein said touchscreen comprises a print command for printing said drawing;
an electronic eraser for erasing a portion of said drawing;
a clear all option for erasing said drawing;
a memory for saving said drawing;
a paper storage compartment;
a software application to upload said drawing to a remote electronic device; and
a microphone for recording a voiceover message with said drawing, wherein said remote electronic device is a smartphone.

20. The multipurpose electronic drawing tablet of claim 19, wherein said remote electronic device is a website.
